(19) United States
(12) Patent Application Publication
(10) Pub. No.: US 2025/0386161 A1
(43) Pub. Date: Dec. 18, 2025

(54) Processing Apparatus, Processing Method, And Non-Transitory Computer-Readable Storage Medium Storing Processing Program

(71) Applicant: SEIKO EPSON CORPORATION, Tokyo (JP)

(72) Inventor: Keisuke HASHIMOTO, Chino (JP)

(21) Appl. No.: 19/240,342

(22) Filed: Jun. 17, 2025

(30) Foreign Application Priority Data
Jun. 18, 2024 (JP) 2024-098019

(51) Int. Cl. H04S 7/00; H04S 1/00

(52) U.S. Cl. CPC H04S 7/301; H04S 1/007; H04S 2400/13; H04S 2420/01

(57) ABSTRACT

A processing apparatus includes a head-related transfer function processing unit that applies a head-related transfer function corresponding to an angle of a virtual sound source with respect to a listening position to monaural sound source data to generate stereo first sound data, a volume panning processing unit that performs volume panning processing on the first sound data based on the angle of the virtual sound source to generate stereo second sound data, and a correction processing unit that corrects a delay amount and a volume of the second sound data based on arrangement information of a plurality of sound output devices to generate stereo third sound data to be output by two of the plurality of sound output devices.

The present application is based on, and claims priority from JP Application Serial Number 2024-098019, filed Jun. 18, 2024, the disclosure of which is hereby incorporated by reference herein in its entirety.

### BACKGROUND

### 1. Technical Field

The present disclosure relates to a processing apparatus, a processing method, and a non-transitory computer-readable storage medium storing a processing program.

### 2. Related Art

WO 2019/116890 describes a signal processing apparatus including a rendering method selection unit that selects one or more methods of rendering processing for localizing a sound image of an audio signal in a listening space from a plurality of methods including panning processing such as VBAP, and a rendering processing unit that performs the rendering processing of the audio signal by the method selected by the rendering method selection unit.

WO 2019/116890 is an example of the related art.

However, in the VBAP, it may be difficult to instantaneously and correctly perceive the direction of the sound, for example, the sound is heard from the front side even though the sound is actually output from the speaker disposed behind. Further, since the VBAP is performed on the assumption of a concentric speaker arrangement, it may be difficult for the listener to perceive the direction of the sound in an environment in which a plurality of speakers are not concentrically arranged with respect to the listener, such as an internal space of an automobile.

### SUMMARY

A processing apparatus according to an aspect of the present disclosure includes a head-related transfer function processing unit that applies a head-related transfer function corresponding to an angle of a virtual sound source with respect to a listening position to monaural sound source data to generate stereo first sound data, a volume panning processing unit that performs volume panning processing on the first sound data based on the angle of the virtual sound source to generate stereo second sound data, and a correction processing unit that corrects a delay amount and a volume of the second sound data based on arrangement information of a plurality of sound output devices to generate stereo third sound data to be output by two of the plurality of sound output devices.

A processing method according to an aspect of the present disclosure includes a head-related transfer function processing step of applying a head-related transfer function corresponding to an angle of a virtual sound source with respect to a listening position to monaural sound source data to generate stereo first sound data, a volume panning processing step of performing volume panning processing on the first sound data based on the angle of the virtual sound source to generate stereo second sound data, and a correction processing step of correcting a delay amount and a volume of the second sound data based on arrangement information of a plurality of sound output devices to generate stereo third sound data to be output by two of the plurality of sound output devices.

A non-transitory computer-readable storage medium storing a processing program according to an aspect of the present disclosure, the program causes a computer to execute a head-related transfer function processing step of applying a head-related transfer function corresponding to an angle of a virtual sound source with respect to a listening position to monaural sound source data to generate stereo first sound data, a volume panning processing step of performing volume panning processing on the first sound data based on the angle of the virtual sound source to generate stereo second sound data, and a correction processing step of correcting a delay amount and a volume of the second sound data based on arrangement information of a plurality of sound output devices to generate stereo third sound data to be output by two of the plurality of sound output devices.

### BRIEF DESCRIPTION OF THE DRAWINGS

FIG. 1 shows a configuration example of a processing apparatus of a first embodiment.

FIG. 2 shows specific processing of a head-related transfer function processing unit.

FIG. 3 shows specific processing of a volume panning processing unit.

FIG. 4 shows specific processing of a correction processing unit.

FIG. 5 is a flowchart showing a procedure of a processing method of a first embodiment.

FIG. 6 is a flowchart showing an example of the procedure of a head-related transfer function processing step in FIG. 5.

FIG. 7 is a flowchart showing an example of the procedure of a volume panning processing step in FIG. 5.

FIG. 8 is a flowchart showing an example of the procedure of a correction processing step in FIG. 5.

FIG. 9 shows a configuration example of a processing apparatus of a second embodiment.

FIG. 10 shows an example of arrangement of a virtual sound source and a virtual noise source.

FIG. 11 shows another example of arrangement of the virtual sound source and the virtual noise source.

FIG. 12 is a flowchart showing a procedure of a processing method of the second embodiment.

FIG. 13 is a flowchart showing an example of the procedure of a second head-related transfer function processing step in FIG. 12.

FIG. 14 is a flowchart showing an example of the procedure of a second volume panning processing step in FIG. 12.

FIG. 15 is a flowchart showing an example of the procedure of a correction processing step in FIG. 12.

FIG. 16 shows a configuration example of a processing apparatus of a third embodiment.

FIG. 17 is a flowchart showing a procedure of a processing method of the third embodiment.

FIG. 18 is a flowchart showing an example of the procedure of a head-related transfer function processing step in FIG. 17.

FIG. 19 shows a configuration example of a processing apparatus of a fourth embodiment.

FIG. 20 is a functional block diagram of an electronic apparatus of an embodiment.

### DESCRIPTION OF EMBODIMENTS

As below, preferred embodiments of the present disclosure will be described in detail using the drawings. Note that the embodiments to be described below do not unduly limit the present disclosure described in What is claimed is. Further, not all configurations to be described below are necessarily essential component elements of the present disclosure.

### 1. Processing Apparatus

### 1-1. First Embodiment

### 1-1-1. Configuration of Processing Apparatus

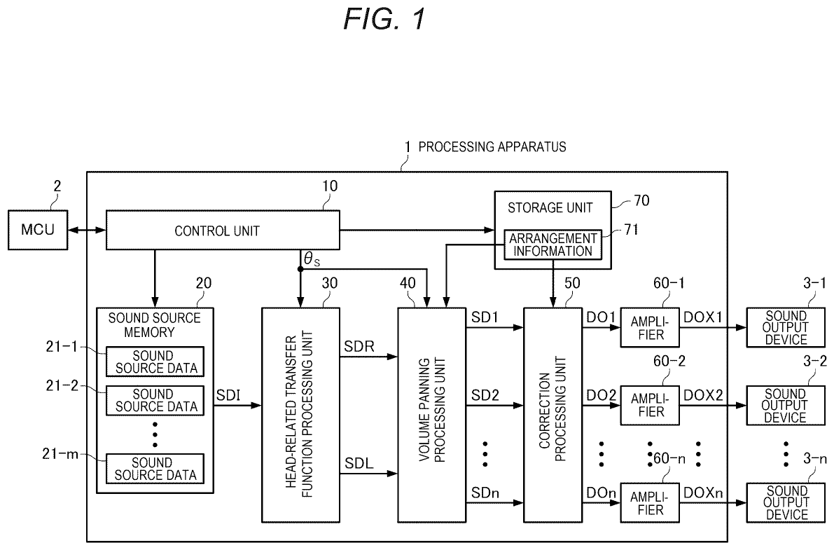

FIG. 1 shows a configuration example of a processing apparatus of a first embodiment. As illustrated in FIG. 1, a processing apparatus 1 of the first embodiment is an apparatus that outputs sound signals DOX1 to DOXn to n sound output devices 3-1 to 3-n, respectively. Here, n is an integer of 2 or more. The sound output devices 3-1 to 3-n may be speakers, for example.

The processing apparatus 1 of the first embodiment includes a control unit 10, a sound source memory 20, a head-related transfer function processing unit 30, a volume panning processing unit 40, a correction processing unit 50, n amplifiers 60-1 to 60-n, and a storage unit 70. The processing apparatus 1 may be a one-chip semiconductor integrated circuit device, may include a plurality of chips of semiconductor integrated circuit devices, or may include electronic components at least partially not semiconductor integrated circuit devices. For example, the control unit 10, the head-related transfer function processing unit 30, the volume panning processing unit 40, the correction processing unit 50, and the storage unit 70 may be implemented by a one-chip semiconductor integrated circuit device, and the sound source memory 20 and the amplifiers 60-1 to 60-n may be provided outside the semiconductor integrated circuit device. The processing apparatus 1 may have a configuration in which part of the component elements in FIG. 1 are omitted or changed, or other component elements are added. For example, the amplifiers 60-1 to 60-n may not be the component elements of the processing apparatus 1.

The sound source memory 20 stores m pieces of monaural sound source data 21-1 to 21-m. m is an integer of 1 or more. The sound source memory 20 may be, for example, a flash memory. Each of the sound source data 21-1 to 21-m may be, for example, pulse code modulated (PCM) audio data or adaptive differential pulse code modulated (ADPCM) audio data. PCM is an abbreviation for Pulse Code Modulation, and ADPCM is an abbreviation for Adaptive Differential Pulse Code Modulation. The sound source data 21-1 to 21-m is, for example, data serving as a basis of various sounds such as a warning sound, a sound effect, and a voice imitating a voice when a person speaks.

The storage unit 70 includes a RAM, a ROM, a register, and the like. RAM is an abbreviation for Random Access Memory and ROM is an abbreviation for Read Only Memory. The storage unit 70 may include a nonvolatile memory.

The control unit 10 is a circuit that performs data communication with a micro control unit 2 and controls the operation of each unit of the processing apparatus 1. The control unit 10 may include, for example, an SPI interface circuit or an I2C interface circuit. SPI is an abbreviation for Serial Peripheral Interface, and I2C is an abbreviation for Inter-Integrated Circuit.

The control unit 10 receives various commands transmitted from the micro control unit 2 and generates various control signals according to the received commands. For example, when receiving a data write command to the storage unit 70, the control unit 10 generates a control signal for writing designated data to an address designated by the command. For example, when receiving a sound reproduction command for the sound source data 21-i among the sound source data 21-1 to 21-m stored in the sound source memory 20, the control unit 10 generates a control signal for instructing to reproduce a sound for the sound source data 21-i. Accordingly, the sound source data 21-i is output from the sound source memory 20 as the sound source data SDI, and is input to the head-related transfer function processing unit 30. If necessary, the sound source data SDI obtained by decoding of the sound source data 21-i by a decoder (not illustrated) may be input to the head-related transfer function processing unit 30. The processing apparatus 1 may include a sound source data generation unit for generating the sound source data SDI in real time.

The head-related transfer function processing unit 30 applies a head-related transfer function corresponding to an angle θ_{S} of a virtual sound source VS with respect to a listening position to the monaural sound source data SDI to generate stereo first sound data. The angle θ_{S} is set based on, for example, an instruction from the micro control unit 2, and is output from the control unit 10. The first sound data includes right sound data SDR and left sound data SDL.

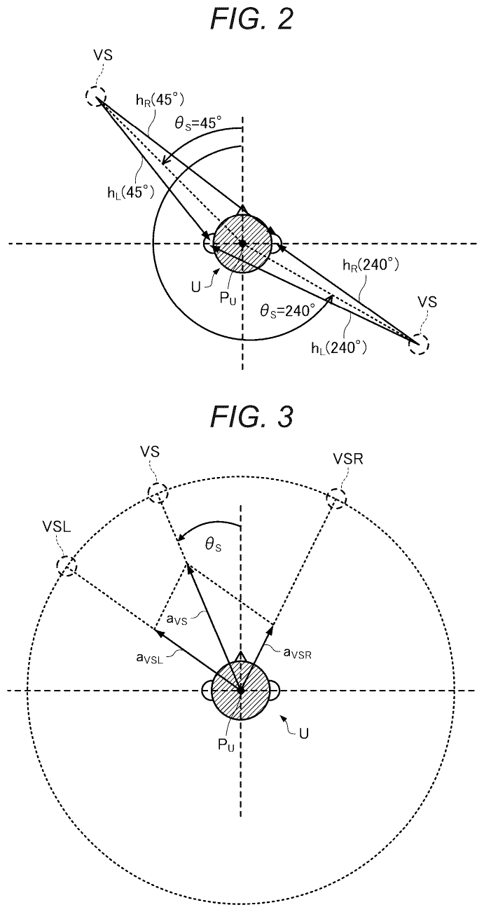

FIG. 2 shows specific processing of the head-related transfer function processing unit 30. As illustrated in FIG. 2, it is assumed that there is the virtual sound source VS that emits a sound corresponding to the sound source data SDI in a direction of the angle θ_{S} with respect to a listening position P_{U} as a position of a listener U. In the embodiment, the angle θ_{S} is a counterclockwise angle as seen from above the listener U with respect to the front direction of the listener U at 0°. Accordingly, as illustrated in FIG. 2, when the angle θ_{S} is 45°, the virtual sound source VS is present in the left front of the listener U, and when the angle θ_{S} is 240°, the virtual sound source VS is present in the right rear of the listener U. A head-related transfer function h_{R}(θS) represents frequency characteristics until the sound emitted by the virtual sound source VS in the direction at the angle θ_{S} reaches the right ear of the listener U. Similarly, a head-related transfer function h_{L}(θ_{S}) represents frequency characteristics until the sound emitted by the virtual sound source VS in the direction at the angle θ_{S} reaches the left ear of the listener U. For example, the sound from the rear of the listener U is blocked by the ears and the high-frequency component is greatly attenuated, and the sound from the front is emphasized or weakened only in a specific frequency band due to the shapes of the ears of the listener U. The head-related transfer functions h_{R}(θ_{S}) and h_{L}(θ_{S}) are transfer functions representing such characteristics. The head-related transfer function processing unit 30 generates right sound data SDR by applying the head-related transfer function h_{R}(θ_{S}) for the right ear to the sound source data SDI, and generates left sound data SDL by applying the head-related transfer function h_{R}(θ_{S}) for the left ear to the sound source data SDI on the assumption that the virtual sound source VS in the direction at the angle θ_{S} emits a sound corresponding to the sound source data SDI.

Returning to the description in FIG. 1, the volume panning processing unit 40 performs volume panning processing on the first sound data generated by the head-related transfer function processing unit 30 based on the angle θ_{S} of the virtual sound source VS to generate n channels of sound data SD1 to SDn including stereo second sound data. The second sound data is any two pieces of the sound data SD1 to SDn, and is determined based on the angle θ_{S} and arrangement information 71 of the sound output devices 3-1 to 3-n. The arrangement information 71 is, for example, information on an angle and a distance of each position of the sound output devices 3-1 to 3-n with respect to the listening position P_{U}, and is stored in the storage unit 70 in advance. However, when the listening position P_{U} changes, the micro control unit 2 may generate the arrangement information 71 based on the listening position P_{U} detected by a sensor (not illustrated) and transmit the arrangement information to the control unit 10, or the micro control unit 2 may transmit the information of the listening position P_{U} to the control unit 10 and the control unit 10 may update the arrangement information 71 according to the listening position P_{U}.

FIG. 3 shows specific processing of the volume panning processing unit 40. There are several types of volume panning, but in the following description, the volume panning is VBAP. VBAP is an abbreviation for Vector-Based Amplitude Panning. As illustrated in FIG. 3, when the virtual sound source VS is present in a direction of the angle θ_{S} with respect to the listening position P_{U}, the sound emitted by the virtual sound source VS is expressed by a vector a_{VS}. The direction of the vector a_{VS} corresponds to the direction from the listening position P_{U} to the virtual sound source VS, and the length of the vector a_{VS} corresponds to the volume of sound emitted by the virtual sound source VS. Considering that the sound emitted by the virtual sound source VS is reproduced using a right virtual sound output device VSR and a left virtual sound output device VSL arranged concentrically with the virtual sound source VS around the listening position P_{U} instead of the virtual sound source VS, the vector a_{VS} is decomposed into a vector a_{VSR} and a vector a_{VSL}. The direction of the vector a_{VSR} corresponds to the direction from the listening position P_{U} to the right virtual sound output device VSR, and the length of the vector a_{VSR} corresponds to the volume of sound emitted by the right virtual sound output device VSR. Similarly, the direction of the vector a_{VSL} corresponds to the direction from the listening position P_{U} to the left virtual sound output device VSL, and the length of the vector a_{VSL} corresponds to the volume of sound emitted by the left virtual sound output device VSL. That is, the right virtual sound output device VSR and the left virtual sound output device VSL in the directions of the vectors a_{VSR} and a_{VSL} are caused to generate sounds corresponding to the respective lengths of the vectors a_{VSR} and a_{VSL} and thereby, the sound emitted by the virtual sound source VS can be reproduced.

The sound volume panning processing unit 40 first selects the two sound output devices 3-r and 3-1 that generate stereo sounds, based on the angle θ_{S} and the arrangement information 71 of the sound output devices 3-1 to 3-n. Each of r and l is an integer from 1 to n. For example, the sound volume panning processing unit 40 specifies the directions of the sound output devices 3-1 to 3-n with respect to the listening position P_{U} based on the arrangement information 71, and selects the sound output device 3-r in the direction closest to the direction of the virtual sound source VS determined by the angle θ_{S} in the rightward direction and the sound output device 3-1 in the direction closest to the direction in the leftward direction.

Then, assuming that the right virtual sound output device VSR and the left virtual sound output device VSL are present in two directions of the sound output devices 3-r and 3-1, respectively, the volume panning processing unit 40 calculates two vectors a_{VSR} and a_{VSL} obtained by decomposing the vector a_{VS} expressing the sound emitted by the virtual sound source VS according to the sound source data SDI into the two directions. Then, the volume panning processing unit 40 sets the length of the vector a_{VSR} to the volume of the right sound data SDR, sets the length of the vector a_{VSL} to the volume of the left sound data SDL, and generates second sound data including the right sound data SDR and the left sound data SDL. The right sound data SDR is the r-th channel sound data SDr corresponding to the sound output device 3-r, and the left sound data SDL is the l-th channel sound data SDl corresponding to the sound output device 3-1. The volume panning processing unit 40 sets the volumes of the sound data other than the sound data SDr and SDl among the n-channels of sound data SD1 to SDn to zero.

Returning to the description in FIG. 1, the correction processing unit 50 corrects the delay amounts and the volumes of the sound data SDr and SDl as the second sound data, generated by the sound volume panning processing unit 40, based on the arrangement information 71 of the sound output devices 3-1 to 3-n, and generates n channels of sound data DO1 to DOn including stereo third sound data to be output by the two sound output devices 3-r and 3-1 among the sound output devices 3-1 to 3-n. The third sound data is two of the r-th channel sound data DOr corresponding to the sound output device 3-r and the 1-th channel sound data DOl corresponding to the sound output device 3-1 among the sound data DO1 to DOn. As described above, the VBAP performed by the sound volume panning processing unit 40 is processing on the assumption that the right virtual sound output device VSR and the left virtual sound output device VSL are arranged concentrically with the virtual sound source VS around the listening position P_{U}. On the other hand, the sound output devices 3-1 to 3-n are not necessarily arranged concentrically around the listening position P_{U}. Accordingly, the volume panning processing unit 40 selects any two of the concentric virtual sound sources VS1 to VSn respectively corresponding to the sound output devices 3-1 to 3-n as the right virtual sound output device VSR and the left virtual sound output device VSL, and applies VBAP. Then, the correction processing unit 50 generates the sound data DOr and DOl by correcting the delay amounts and the volumes of the sound data SDr and SDl.

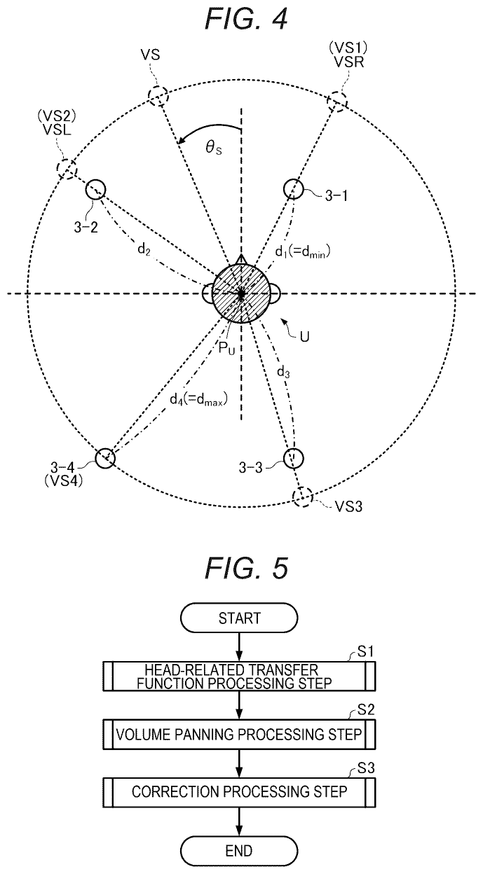

FIG. 4 shows specific processing of the correction processing unit 50. In FIG. 4, the positions of the virtual sound source VS, the right virtual sound output device VSR, and the left virtual sound output device VSL with respect to the listening position P_{U} are the same as those in FIG. 3. In FIG. 4, the four sound output devices 3-1 to 3-4 are arranged around the listener U, but the sound output devices 3-1 to 3-4 are not arranged concentrically with respect to the listening position P_{U}. Accordingly, for example, the sound volume panning processing unit 40 generates the sound data SD1 and SD2 as the sound data SDr and SDl on the assumption that the virtual sound source VS is arranged in the direction at the angle θ_{S}, the right virtual sound output device VSR is arranged in the direction of the sound output device 3-1, and the left virtual sound output device VSL is arranged in the direction of the sound output device 3-2 concentrically with the sound output device 3-3 farthest from the listening position P_{U}. On the other hand, since the sound output devices 3-1 and 3-2 are not concentrically arranged with respect to the listening position P_{U} and the sound output devices 3-1 and 3-2 are closer to the listening position P_{U} than the right virtual sound output device VSR and the left virtual sound output device VSL, respectively, when the sounds corresponding to the sound data SD1 and SD2 are output from the sound output devices 3-1 and 3-2, respectively, the listener U does not feel that a sound is emitted from the virtual sound source VS.

The correction processing unit 50 first acquires distances d₁ to d₄ from the listening position P_{U} to the respective sound output devices 3-1 to 3-4 based on the arrangement information 71. Then, the correction processing unit 50 corrects the sound data SD1 to SD4 to increase the delay amounts according to ratios between the maximum distance dₘₐₓ among the distances d₁ to d₄ and the respective distances d₁ to d₄. Further, the correction processing unit 50 corrects the sound data SD1 to SD4 to decrease the volumes according to the ratios between the maximum distance dₘₐₓ among the distances d₁ to d₄ and the respective distances d₁ to d₄. Then, the correction processing unit 50 outputs the sound data SD1 to SD4 with the corrected delay amounts and volumes as the sound data DO1 to DO4. When the sound output devices 3-1 and 3-2 are caused to output sounds corresponding to the sound data DO1 and DO2, respectively, the listener U can feel as if a sound was emitted from the virtual sound source VS. On the other hand, since the volumes of the sound data SD3 and SD4 before correction are set to zero, the volumes of the sound data DO3 and DO4 also become zero, and the sounds corresponding to the sound data DO3 and DO4 are not output from the sound output devices 3-3 and 3-4.

Since it is not easy for the correction processing unit 50 to correct the second sound data to decrease the delay amount, it is preferable to correct the second sound data to increase the delay amount with reference to the distance dₘₐₓ from the listening position P_{U} to the sound output device 3-j farthest from the listening position P_{U}. On the other hand, since it is easy to correct the second sound data to decrease and increase the volume, the correction processing unit 50 may correct the second sound data to decrease the volume with reference to the distance dₘₐₓ from the listening position P_{U} to the sound output device 3-j farthest from the listening position P_{U}, or may correct the second sound data to increase the volume with reference to the distance dₘᵢₙ from the listening position P_{U} to the sound output device 3-i closest to the listening position P_{U}. In the latter case, for example, the volume panning processing unit 40 may set the volume of the second sound data with reference to the distance dₘᵢₙ from the listening position P_{U} to the closest sound output device 3-i.

Returning to the description in FIG. 1, the amplifiers 60-1 to 60-n convert the n-channels of sound data DO1 to DOn output from the correction processing unit 50 into sound signals DOX1 to DOXn and output the sound signals DOX1 to DOXn to the sound output devices 3-1 to 3-n, respectively. Accordingly, sounds corresponding to the sound signals DOX1 to DOXn are output from the sound output devices 3-1 to 3-n, respectively. The sound output from each of the sound output devices 3-1 to 3-n may be, for example, various sounds such as a warning sound and a sound effect, or may be a voice imitating a voice when a person speaks.

In FIG. 1, the sound source data 21-1 to 21-m is stored in the sound source memory 20 inside the processing apparatus 1, but may be stored in an external memory of the processing apparatus 1. Further, the sound source data 21-1 to 21-m may be stored in a memory built in the micro control unit 2, and the micro control unit 2 may transmit the sound source data SDI to the processing apparatus 1 together with the sound reproduction command.

### 1-1-2. Procedure of Processing Method

FIG. 5 is a flowchart showing a procedure of a processing method of the first embodiment. The processing method of the first embodiment is executed by the processing apparatus 1 of the first embodiment shown in FIG. 1.

As illustrated in FIG. 5, first, in a head-related transfer function processing step S1, the processing apparatus 1 applies a head-related transfer function corresponding to the angle θ_{S} of the virtual sound source VS with respect to the listening position P_{U} to monaural sound source data SDI to generate stereo first sound data. The head-related transfer function processing step S1 is executed by the head-related transfer function processing unit 30 of the processing apparatus 1.

Then, in a volume panning processing step S2, the processing apparatus 1 performs volume panning processing on the first sound data, generated in the head-related transfer function processing step S1, based on the angle θ_{S} of the virtual sound source VS to generate stereo second sound data. The volume panning processing step S2 is executed by the volume panning processing unit 40 of the processing apparatus 1.

Finally, in a correction processing step S3, the processing apparatus 1 corrects the delay amount and the volume of the second sound data, generated in the volume panning processing step S2, based on the arrangement information 71 of the sound output devices 3-1 to 3-n, and generates stereo third sound data to be output by two of the sound output devices 3-1 to 3-n. In the correction processing step S3, the processing apparatus 1 may correct the delay amount of the second sound data with reference to the distance dₘₐₓ from the listening position P_{U} to the farthest sound output device 3-j among the sound output devices 3-1 to 3-n. The processing apparatus 1 may correct the volume of the second sound data with reference to the distance dₘₐₓ from the listening position P_{U} to the farthest sound output device 3-j or the distance dₘᵢₙ to the closest sound output device 3-i among the sound output devices 3-1 to 3-n. The correction processing step S3 is executed by the correction processing unit 50 of the processing apparatus 1.

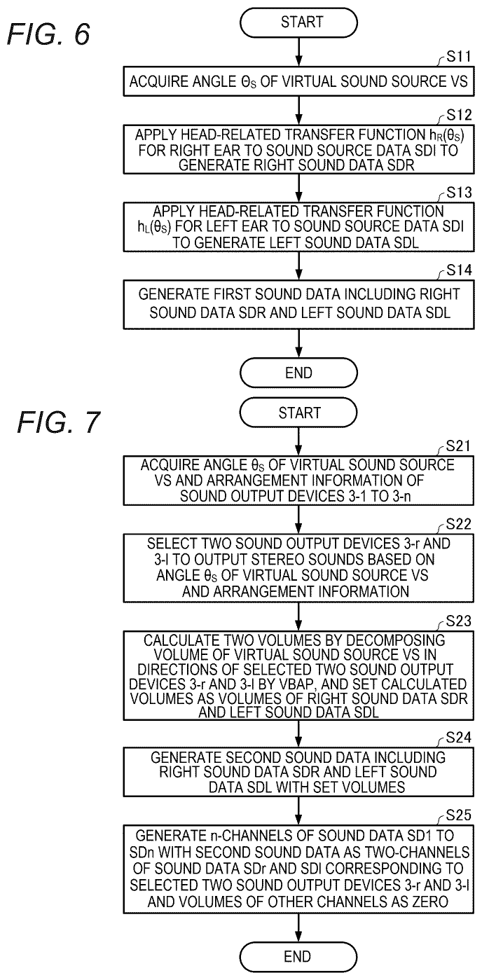

FIG. 6 is a flowchart showing an example of the procedure of the head-related transfer function processing step S1 in FIG. 5. As illustrated in FIG. 6, first, in step S11, the processing apparatus 1 acquires the angle θ_{S} of the virtual sound source VS. Then, in step S12, the processing apparatus 1 applies the head-related transfer function h_{R}(θ_{S}) for the right ear to the sound source data SDI to generate the right sound data SDR. In step S13, the processing apparatus 1 applies the head-related transfer function h_{L}(θ_{S}) for the left ear to the sound source data SDI to generate the left sound data SDL. Finally, in step S14, the processing apparatus 1 generates first sound data including the right sound data SDR and the left sound data SDL.

FIG. 7 is a flowchart showing an example of the procedure of the volume panning processing step S2 in FIG. 5. As illustrated in FIG. 7, first, in step S21, the processing apparatus 1 acquires the angle θ_{S} of the virtual sound source VS and the arrangement information 71 of the sound output devices 3-1 to 3-n. Then, in step S22, the processing apparatus 1 selects the two sound output devices 3-r and 3-1 that output stereo sounds, based on the angle θ_{S} of the virtual sound source VS and the arrangement information 71. Then, in step S23, the processing apparatus 1 calculates two volumes obtained by decomposing the volume of the virtual sound source VS in the directions of the two sound output devices 3-r and 3-1 selected in step S22 by VBAP, and sets the calculated volumes as the volumes of the right sound data SDR and the left sound data SDL. Then, in step S24, the processing apparatus 1 generates second sound data including the right sound data SDR and the left sound data SDL with volumes set in step S23. Finally, in step S25, the processing apparatus 1 generates n channels of sound data SD1 to SDn with the second sound data generated in step S24 as two channels of sound data SDr and SDl corresponding to the two sound output devices 3-r and 3-1 selected in step S22 and the volumes of the other channels as zero.

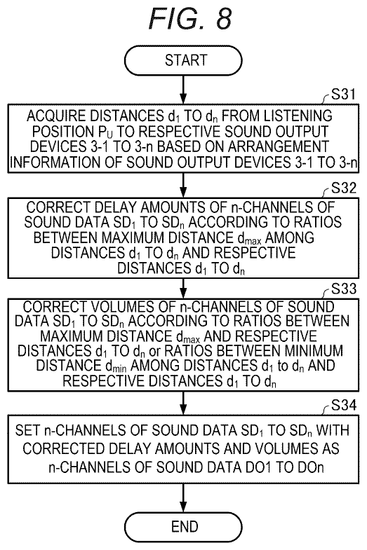

FIG. 8 is a flowchart showing an example of the procedure of the correction processing step S3 in FIG. 5. As illustrated in FIG. 8, first, in step S31, the processing apparatus 1 acquires distances d₁ to dₙ from the listening position P_{U} to the respective sound output devices 3-1 to 3-n based on the arrangement information 71 of the sound output devices 3-1 to 3-n. Then, in step S32, the processing apparatus 1 corrects the delay amounts of the n-channels of sound data SD1 to SDn according to the ratios between the maximum distance dₘₐₓ among the distances d₁ to dₙ and the respective distances d₁ to dₙ. Further, in step S33, the processing apparatus 1 corrects the volumes of the n channels of sound data SD1 to SDn according to the ratios between the maximum distance dₘₐₓ and the respective distances d₁ to dₙ or the ratios between the minimum distance dₘᵢₙ among the distances d₁ to dₙ and the respective distances d₁ to dₙ. Finally, in step S34, the processing apparatus 1 sets the n-channels of sound data SD1 to SDn with the corrected delay amounts and volumes in steps S32 and S33 as n-channels of sound data DO1 to DOn.

### 1-1-3. Functions and Effects

As described above, according to the processing apparatus 1 of the first embodiment, the head-related transfer function processing unit 30 can generate the right sound data SDR and the left sound data SDL by adding the frequency characteristics for the listener U to easily instantaneously sense the direction to the sound source data SDI. Further, according to the processing apparatus 1 of the first embodiment, the correction processing unit 50 corrects the delay amounts and the volumes of the sound data SD1 to SDn, and thereby, a state in which the sound output devices 3-1 to 3-n are virtually concentrically arranged can be created. Even when the sound output devices 3-1 to 3-n are not concentrically arranged, VBAP by the sound volume panning processing unit 40 can be applied and the sound data DO1 to DOn for the listener U to easily perceive the direction of the sound can be generated. Therefore, for example, when the sound corresponding to the sound source data SDI is a warning sound, the listener U can correctly perceive the direction of the warning sound output from the sound output devices 3-1 to 3-n and quickly and accurately recognize the situation. Further, for example, when the sound corresponding to the sound source data SDI is a sound effect or a voice, the listener U can correctly perceive the direction of the sound effect or the voice output from the sound output devices 3-1 to 3-n, and can obtain a high sense of presence or immersion.

### 1-2. Second Embodiment

As below, regarding a processing apparatus 1 of a second embodiment, the same configurations as those of the first embodiment will have the same signs and the same descriptions as those of the first embodiment will be omitted or simplified, and the differences from the first embodiment will be mainly described.

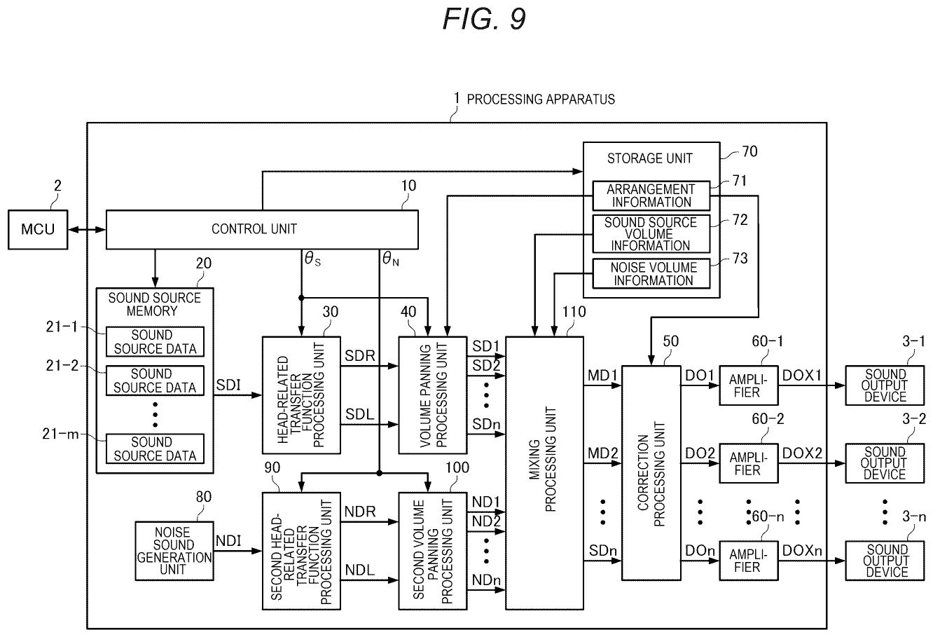

FIG. 9 shows a configuration example of the processing apparatus 1 of the second embodiment. As illustrated in FIG. 9, similarly to the processing apparatus 1 of the first embodiment, the processing apparatus 1 of the second embodiment includes a control unit 10, a sound source memory 20, a head-related transfer function processing unit 30, a volume panning processing unit 40, a correction processing unit 50, n amplifiers 60-1 to 60-n, and a storage unit 70. The processing apparatus 1 of the second embodiment further includes a noise sound generation unit 80, a second head-related transfer function processing unit 90, a second volume panning processing unit 100, and a mixing processing unit 110. The processing apparatus 1 may be a one-chip semiconductor integrated circuit device, may include a plurality of chips of semiconductor integrated circuit devices, or may include electronic components at least partially not semiconductor integrated circuit devices. For example, the control unit 10, the head-related transfer function processing unit 30, the volume panning processing unit 40, the correction processing unit 50, the storage unit 70, the noise sound generation unit 80, the second head-related transfer function processing unit 90, the second volume panning processing unit 100, and the mixing processing unit 110 may be implemented by a one-chip semiconductor integrated circuit device, and the sound source memory 20 and the amplifiers 60-1 to 60-n may be provided outside the semiconductor integrated circuit device. The processing apparatus 1 may have a configuration in which part of the component elements in FIG. 9 are omitted or changed, or other component elements are added. For example, the amplifiers 60-1 to 60-n may not be the component elements of the processing apparatus 1.

The noise sound generation unit 80 generates monaural noise source data NDI in real time. The noise source data NDI may be, for example, white noise having a uniform energy distribution or pink noise having an energy distribution inversely proportional to a frequency. The noise source data NDI generated by the noise sound generation unit 80 is input to the second head-related transfer function processing unit 90. The noise source data NDI may be stored in the sound source memory 20 in advance.

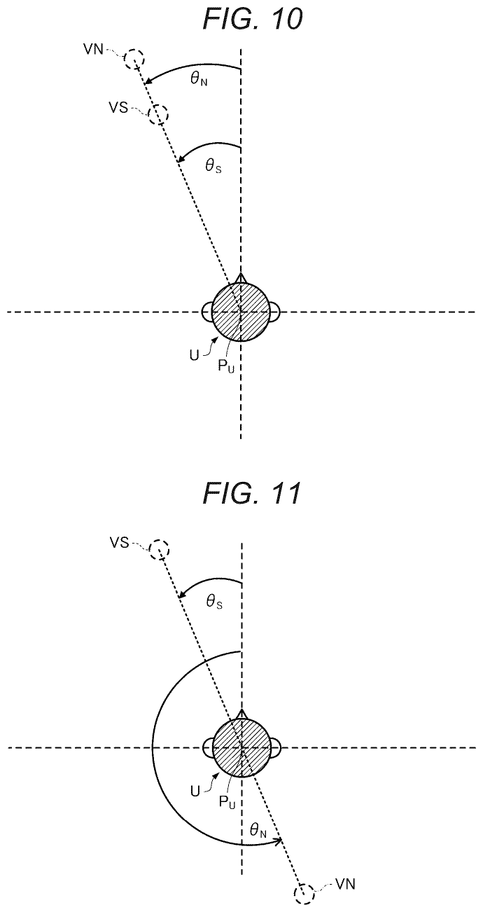

The second head-related transfer function processing unit 90 applies a head-related transfer function corresponding to an angle θ_{N} of a virtual noise source VN with respect to a listening position P_{U} to the monaural noise source data NDI to generate stereo first noise data. The angle θ_{N} is set based on, for example, an instruction from the micro control unit 2, and is output from the control unit 10. The first noise data includes right noise data NDR and left noise data NDL. Specifically, the second head-related transfer function processing unit 90 generates the right noise data NDR by applying a head-related transfer function h_{R} (θ_{N}) for the right ear to the noise source data NDI and generates the left noise data NDL by applying a head-related transfer function h_{L}(θ_{N}) for the left ear to the noise source data NDI on the assumption that the virtual noise source VN in the direction at the angle θ_{N} emits a sound corresponding to the noise source data NDI. As illustrated in FIG. 10, the angle θ_{S} of the virtual sound source VS and the angle θ_{N} of the virtual noise source VN may be the same. As illustrated in FIG. 11, the difference between the angle θ_{S} of the virtual sound source VS and the angle θ_{N} of the virtual noise source VN may be 90° or more.

The second volume panning processing unit 100 performs volume panning processing on the first noise data, generated by the second head-related transfer function processing unit 90, based on the angle θ_{N} of the virtual noise source VN to generate n channels of noise data ND1 to NDn including stereo second noise data. The second noise data is any two pieces of the noise data ND1 to NDn, and is determined based on the angle θ_{N} and the arrangement information 71 of the sound output devices 3-1 to 3-n.

Specifically, the second volume panning processing unit 100 first selects two sound output devices 3-rn and 3-ln that generate a stereo noise sound based on the angle θ_{N} and the arrangement information 71 of the sound output devices 3-1 to 3-n. Each of rn and ln is an integer from 1 to n. For example, the second volume panning processing unit 100 specifies the directions of the sound output devices 3-1 to 3-n with respect to the listening position P_{U} based on the arrangement information 71, and selects the sound output device 3-rn in the direction closest to the direction of the virtual noise source VN determined by the angle θ_{N} in the rightward direction and the sound output device 3-ln in the direction closest to the direction in the leftward direction. Then, assuming that a right virtual noise source VNR and a left virtual noise source VNL are present in two directions of the sound output devices 3-rn and 3-ln, the second volume panning processing unit 100 calculates two vectors a_{VNR} and a_{VNL} obtained by decomposing the vector av expressing the sound emitted by the virtual noise source VN according to the noise source data NDI into the two directions. Then, the second volume panning processing unit 100 sets the length of the vector a_{VNR} to the volume of the right noise data NDR, sets the length of the vector a_{VNL} to the volume of the left noise data NDL, and generates second noise data including the right noise data NDR and the left noise data NDL. The right noise data NDR is rn-channel noise data NDrn corresponding to the sound output device 3-rn, and the left noise data NDL is ln-channel noise data NDln corresponding to the sound output device 3-ln. The second volume panning processing unit 100 sets the volumes of the noise data other than the noise data NDrn and NDln among the n-channel noise data ND1 to NDn to zero.

The mixing processing unit 110 mixes the second sound data generated by the volume panning processing unit 40 and the second noise data generated by the second volume panning processing unit 100 to generate mixing data. Specifically, the mixing processing unit 110 sets the second sound data to the volume designated by sound source volume information 72, sets the second noise data to the volume designated by noise volume information 73, and mixes the n-channels of sound data SD1 to SDn including the second sound data and the n-channels of noise data ND1 to NDn including the second noise data to generate the n-channels of mixing data MD1 to MDn. The sound source volume information 72 and the noise volume information 73 are stored in the storage unit 70 in advance. However, the micro control unit 2 may generate the sound source volume information 72 and the noise volume information 73 and transmit the information to the control unit 10.

The correction processing unit 50 corrects the delay amounts and the volumes of the sound data SDr and SDl as the second sound data contained in the mixing data, generated by the mixing processing unit 110, based on the arrangement information 71 of the sound output devices 3-1 to 3-n, and generates stereo third sound data to be output by the two sound output devices 3-r and 3-1 among the sound output devices 3-1 to 3-n. Further, the correction processing unit 50 corrects the delay amounts and the volumes of the noise data NDrn and NDln as the second noise data contained in the mixing data, generated by the mixing processing unit 110, based on the arrangement information 71, and generates stereo third noise data to be output by the two sound output devices 3-rn and 3-ln among the sound output devices 3-1 to 3-n. Then, the correction processing unit 50 outputs the n-channels of sound data DO1 to DOn including the sound data SDr and SDl with the corrected delay amounts and volumes as the third sound data, and the noise data NDrn and NDln with the corrected delay amounts and volumes as the third noise data. The third noise data is contained in the rn-channel sound data DOrn corresponding to the sound output device 3-rn and the ln-channel sound data DOln corresponding to the sound output device 3-ln among the sound data DO1 to DOn.

Specifically, the correction processing unit 50 first acquires the distances d₁ to d₄ from the listening position P_{U} to the respective sound output devices 3-1 to 3-n based on the arrangement information 71. Then, the correction processing unit 50 corrects the mixing data MD1 to MDn to increase the delay amounts according to ratios between the maximum distance dₘₐₓ among the distances d₁ to dₙ and the respective distances d₁ to dₙ. Further, the correction processing unit 50 corrects the mixing data MD1 to MDn to decrease the volumes according to the ratios between the maximum distance dₘₐₓ among the distances d₁ to dₙ and the respective distances d₁ to dₙ. Then, the correction processing unit 50 outputs the mixing data MD1 to MDn with the corrected delay amounts and volumes as the sound data DO1 to DOn.

Since it is not easy for the correction processing unit 50 to correct the second noise data to decrease the delay amount, it is preferable to correct the second noise data to increase the delay amount with reference to the distance dₘₐₓ from the listening position P_{U} to the sound output device 3-j farthest from the listening position P_{U}. On the other hand, since it is easy to correct the second noise data to decrease and increase the volume, the correction processing unit 50 may correct the second noise data to decrease the volume with reference to the distance dₘₐₓ from the listening position P_{U} to the sound output device 3-j farthest from the listening position P_{U}, or may correct the second noise data to increase the volume with reference to the distance dₘᵢₙ from the listening position P_{U} to the sound output device 3-i closest to the listening position P_{U}. In the latter case, for example, the second volume panning processing unit 100 may set the volume of the second noise data with reference to the distance dₘᵢₙ from the listening position P_{U} to the closest sound output device 3-i.

Other configurations and functions of the processing apparatus 1 of the second embodiment are the same as those of the processing apparatus 1 of the first embodiment, and thus description thereof will be omitted.

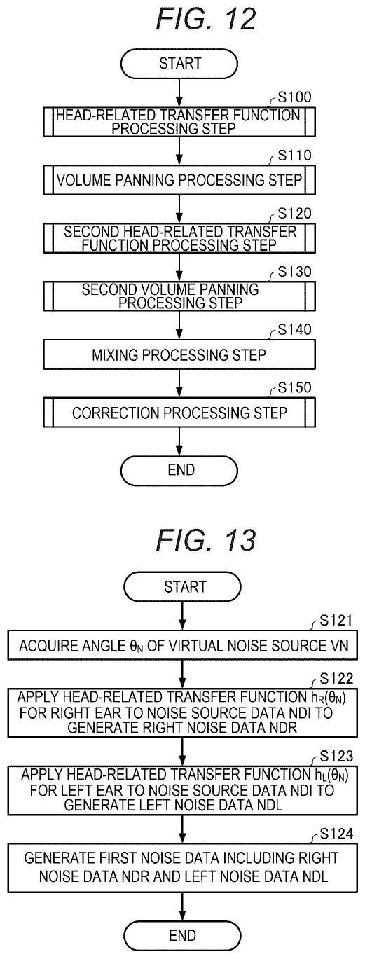

FIG. 12 is a flowchart showing a procedure of a processing method of the second embodiment. The processing method of the second embodiment is executed by the processing apparatus 1 of the second embodiment shown in FIG. 9. As illustrated in FIG. 12, first, similarly to the first embodiment, the processing apparatus 1 performs the head-related transfer function processing step S100 and the volume panning processing step S110 to generate stereo second sound data. The processing in the head-related transfer function processing step S100 is the same as the processing in the head-related transfer function processing step S1 in FIG. 5 and the specific procedure thereof is the same as the procedure in FIG. 6, and thus illustration and description thereof will be omitted. The head-related transfer function processing step S100 is executed by the head-related transfer function processing unit 30 of the processing apparatus 1. Similarly, the processing of the volume panning processing step S110 is the same as the processing of the volume panning processing step S2 in FIG. 5 and the specific procedure thereof is the same as the procedure in FIG. 7, and thus illustration and description thereof will be omitted. The volume panning processing step S110 is executed by the volume panning processing unit 40 of the processing apparatus 1.

Then, in a second head-related transfer function processing step S120, the processing apparatus 1 applies a head-related transfer function corresponding to the angle θ_{N} of the virtual noise source VN with respect to the listening position P_{U} to the monaural noise source data NDI to generate stereo first noise data. The second head-related transfer function processing step S120 is executed by the second head-related transfer function processing unit 90 of the processing apparatus 1.

Then, in a second volume panning processing step S130, the processing apparatus 1 performs volume panning processing on the first noise data generated in the second head-related transfer function processing step S120 based on the angle θ_{N} of the virtual noise source VN to generate stereo second noise data. Specifically, the processing apparatus 1 mixes the n-channels of sound data SD1 to SDn including the second sound data and the n-channels of noise data ND1 to NDn including the second noise data to generate the n-channels of mixing data MD1 to MDn. The second volume panning processing step S130 is executed by the second volume panning processing unit 100 of the processing apparatus 1.

Then, in a mixing processing step S140, the processing apparatus 1 mixes the second sound data generated in the volume panning processing step S110 and the second noise data generated in the second volume panning processing step S130 to generate mixing data. The mixing processing step S140 is executed by the mixing processing unit 110 of the processing apparatus 1.

Finally, in a correction processing step S150, the processing apparatus 1 corrects the delay amount and the volume of the second sound data contained in the mixing data, generated in the mixing processing step S140, based on the arrangement information 71 of the sound output devices 3-1 to 3-n, and generates stereo third sound data to be output by two of the sound output devices 3-1 to 3-n. Further, the processing apparatus 1 corrects the delay amount and the volume of the second noise data contained in the mixing data, generated in the mixing processing step S140, based on the arrangement information 71, and generates stereo third noise data to be output by two of the sound output devices 3-1 to 3-n. In the correction processing step S150, the processing apparatus 1 may correct the delay amounts of the second sound data and the second noise data with reference to the distance dₘₐₓ from the listening position P_{U} to the farthest sound output device 3-j among the sound output devices 3-1 to 3-n. The processing apparatus 1 may correct the volumes of the second sound data and the second noise data with reference to the distance dₘₐₓ from the listening position P_{U} to the farthest sound output device 3-j or the distance dₘᵢₙ to the closest sound output device 3-i among the sound output devices 3-1 to 3-n. The correction processing step S150 is executed by the correction processing unit 50 of the processing apparatus 1.

FIG. 13 is a flowchart showing an example of the procedure of the second head-related transfer function processing step S120 in FIG. 12. As illustrated in FIG. 13, first, in step S121, the processing apparatus 1 acquires an angle θ_{N} of the virtual noise source VN. Then, in step S122, the processing apparatus 1 applies the head-related transfer function h_{R}(θ_{N}) for the right ear to the noise source data NDI to generate the right noise data NDR. In step S123, the processing apparatus 1 applies the head-related transfer function hi (θ_{N}) for the left ear to the noise source data NDI to generate the left noise data NDL. Finally, in step S124, the processing apparatus 1 generates first noise data including the right noise data NDR and the left noise data NDL.

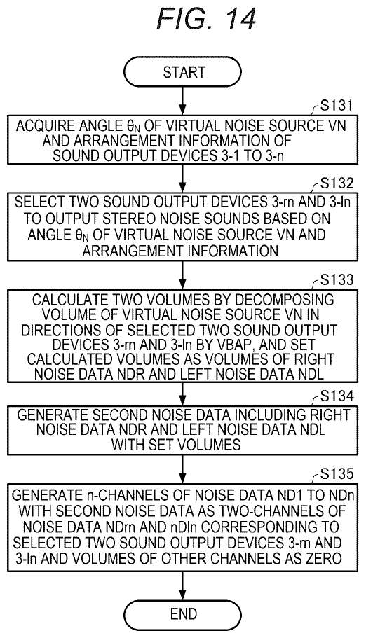

FIG. 14 is a flowchart showing an example of the procedure of the second volume panning processing step S130 in FIG. 12. As illustrated in FIG. 14, first, in step S131, the processing apparatus 1 acquires the angle θ_{N} of the virtual noise source VN and the arrangement information 71 of the sound output devices 3-1 to 3-n. Then, in step S132, the processing apparatus 1 selects two sound output devices 3-rn and 3-ln that output a stereo noise sound, based on the angle θ_{N} of the virtual noise source VN and the arrangement information 71. Then, in step S133, the processing apparatus 1 calculates two volumes obtained by decomposing the volume of the virtual noise source VN in the directions of the two sound output devices 3-rn and 3-In selected in step S132 by VBAP, and sets the volumes of the right noise data NDR and the left noise data NDL. Then, in step S134, the processing apparatus 1 generates second noise data including the right noise data NDR and the left noise data NDL for which the volumes are set in step S133. Finally, in step S135, the processing apparatus 1 generates n-channels of noise data ND1 to NDn with the second noise data generated in step S134 as two channels of noise data NDrn and NDln corresponding to the two sound output devices 3-rn and 3-ln selected in step S132 and the volumes of the other channels as zero.

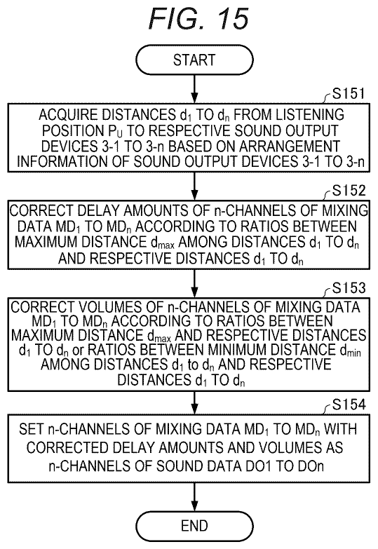

FIG. 15 is a flowchart showing an example of the procedure of the correction processing step S150 in FIG. 12. As illustrated in FIG. 15, first, in step S151, the processing apparatus 1 acquires distances d₁ to dₙ from the listening position P_{U} to the respective sound output devices 3-1 to 3-n based on the arrangement information 71 of the sound output devices 3-1 to 3-n. Then, in step S152, the processing apparatus 1 corrects the delay amounts of the n-channels of mixing data MD1 to MDn according to the ratios between the maximum distance dₘₐₓ among the distances d₁ to dₙ and the respective distances d₁ to dₙ. Further, in step S153, the processing apparatus 1 corrects the volumes of the n-channels of mixing data MD1 to MDn generated in the mixing processing step S140 according to the ratios between the maximum distance dₘₐₓ and the respective distances d₁ to dₙ or the ratios of the minimum distance dₘᵢₙ among the distances d₁ to dₙ and the respective distances d₁ to dₙ. Finally, in step S154, the processing apparatus 1 sets the n-channels of mixing data MD1 to MDn with the delay amounts and volumes corrected in steps S152 and S153 as the n-channels of sound data DO1 to DOn.

According to the above described processing apparatus 1 of the second embodiment, even when the sound source data SDI is a sound having only a narrow frequency spectrum, a noise sound in a wide band in which a direction is easily perceived is added, and thus sound data for the listener U to perceive the direction of the sound more easily can be generated. In addition, according to the processing apparatus 1 of the second embodiment, the same effects as those of the processing apparatus 1 of the first embodiment can be obtained.

### 1-3. Third Embodiment

As below, regarding the processing apparatus 1 of the third embodiment, the same configurations as those of the first embodiment or the second embodiment will have the same signs, the same descriptions as those of the first embodiment or the second embodiment will be omitted or simplified, and the differences from the first embodiment and the second embodiment will be mainly described.

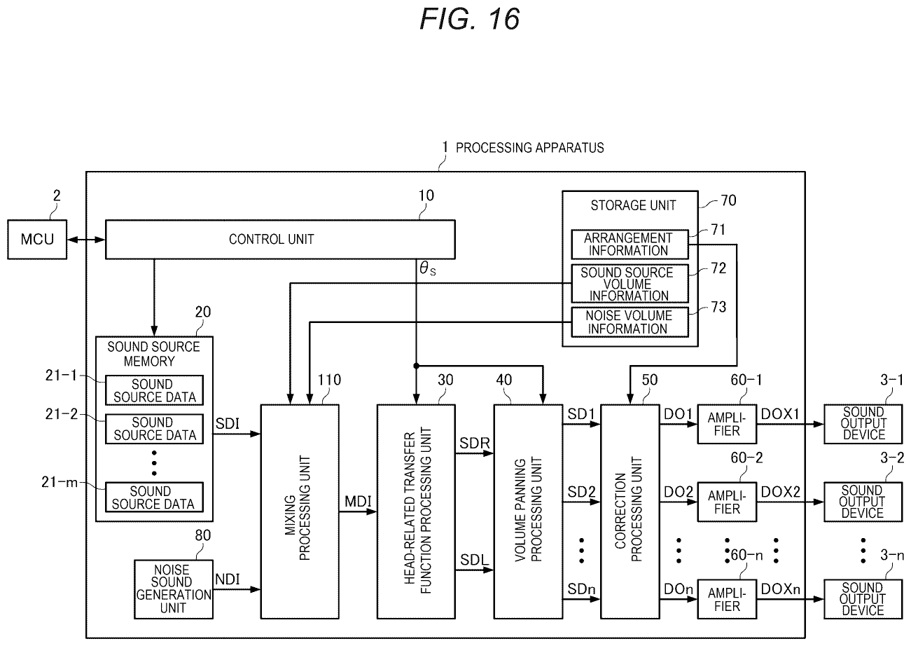

FIG. 16 shows a configuration example of the processing apparatus 1 of the third embodiment. As illustrated in FIG. 16, the processing apparatus 1 of the third embodiment includes a control unit 10, a sound source memory 20, a head-related transfer function processing unit 30, a volume panning processing unit 40, a correction processing unit 50, n amplifiers 60-1 to 60-n, a storage unit 70, a noise sound generation unit 80, and a mixing processing unit 110. The processing apparatus 1 may be a one-chip semiconductor integrated circuit device, may include a plurality of chips of semiconductor integrated circuit devices, or may include electronic components at least partially not semiconductor integrated circuit devices. For example, the control unit 10, the head-related transfer function processing unit 30, the volume panning processing unit 40, the correction processing unit 50, the noise sound generation unit 80, and the mixing processing unit 110 may be implemented by a one-chip semiconductor integrated circuit device, and the sound source memory 20 and the amplifiers 60-1 to 60-n may be provided outside the semiconductor integrated circuit device. The processing apparatus 1 may have a configuration in which part of the component elements in FIG. 16 are omitted or changed, or other component elements are added. For example, the amplifiers 60-1 to 60-n may not be the component elements of the processing apparatus 1.

The mixing processing unit 110 mixes the monaural sound source data SDI and the monaural noise source data NDI generated by the noise sound generation unit 80 to generate mixing data MDI. Specifically, the mixing processing unit 110 sets the sound source data SDI to the volume designated by the sound source volume information 72, sets the noise source data NDI to the volume designated by the noise volume information 73, and mixes the sound source data SDI and the noise source data NDI to generate the mixing data MDI.

In the embodiment, the angle θ_{S} of the virtual sound source VS and the angle θ_{N} of the virtual noise source VN with respect to the listening position P_{U} are the same, and the head-related transfer function processing unit 30 applies a head-related transfer function corresponding to the angles θ_{S} of the virtual sound source VS and the virtual noise source VN to the monaural mixing data MDI to generate stereo first sound data. The first sound data includes right sound data SDR and left sound data SDL. Specifically, the head-related transfer function processing unit 30 generates the right sound data SDR by applying the head-related transfer function h_{R}(θ_{S}) for the right ear to the mixing data MDI and generates the left sound data SDL by applying the head-related transfer function h_{R}(θ_{S}) for the left ear to the mixing data MDI on the assumption that the virtual sound source VS in the direction at the angle θ_{S} emits a sound corresponding to the sound source data SDI and the virtual noise source VN in the direction at the angle θ_{S} emits a sound corresponding to the noise source data NDI.

The processing of the sound volume panning processing unit 40, the correction processing unit 50, and the amplifiers 60-1 to 60-n is the same as that of the first embodiment, and thus the description thereof will be omitted. The processing of the noise sound generation unit 80 is the same as that of the second embodiment, and thus the description thereof will be omitted.

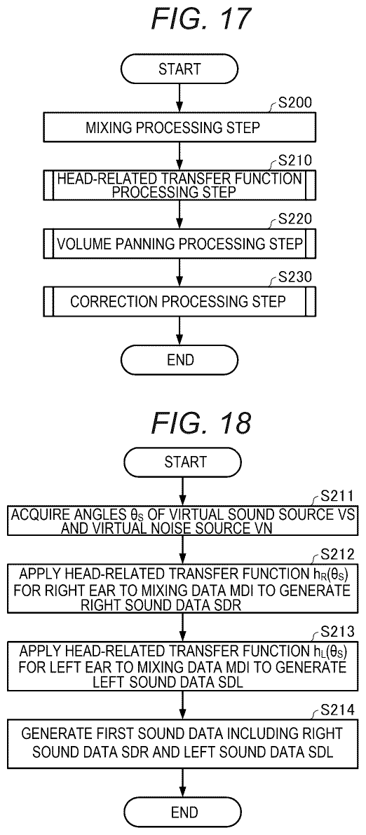

FIG. 17 is a flowchart showing a procedure of a processing method of the third embodiment. The processing method of the third embodiment is executed by the processing apparatus 1 of the third embodiment shown in FIG. 16.

As illustrated in FIG. 17, first, in a mixing processing step S200, the processing apparatus 1 mixes monaural sound source data SDI and monaural noise source data NDI to generate mixing data MDI. The mixing processing step S200 is executed by the mixing processing unit 110 of the processing apparatus 1.

Then, in a head-related transfer function processing step S210, the processing apparatus 1 applies a head-related transfer function corresponding to the angle θ_{S} of the virtual sound source VS and the virtual noise source VN with respect to the listening position P_{U} to the monaural mixing data MDI generated in the mixing processing step S200 to generate stereo first sound data. The head-related transfer function processing step S210 is executed by the head-related transfer function processing unit 30 of the processing apparatus 1.

Then, in a volume panning processing step S220, the processing apparatus 1 performs volume panning processing on the first sound data, generated in the head-related transfer function processing step S210, based on the angle θ_{S} of the virtual sound source VS and the virtual noise source VN to generate stereo second sound data. The volume panning processing step S220 is executed by the volume panning processing unit 40 of the processing apparatus 1.

Finally, in a correction processing step S230, the processing apparatus 1 corrects the delay amount and the volume of the second sound data, generated in the volume panning processing step S220, based on the arrangement information 71 of the sound output devices 3-1 to 3-n, and generates stereo third sound data to be output by two of the sound output devices 3-1 to 3-n. In the correction processing step S230, the processing apparatus 1 may correct the delay amount of the second sound data with reference to the distance dₘₐₓ from the listening position P_{U} to the farthest sound output device 3-j among the sound output devices 3-1 to 3-n. The processing apparatus 1 may correct the volume of the second sound data with reference to the distance dₘₐₓ from the listening position P_{U} to the farthest sound output device 3-j or the distance dₘᵢₙ to the closest sound output device 3-i among the sound output devices 3-1 to 3-n. The correction processing step S230 is executed by the correction processing unit 50 of the processing apparatus 1.

FIG. 18 is a flowchart showing an example of the procedure of the head-related transfer function processing step S210 in FIG. 17. As illustrated in FIG. 18, first, in step S211, the processing apparatus 1 acquires angles θ_{S} of the virtual sound source VS and the virtual noise source VN. Then, in step S212, the processing apparatus 1 applies the head-related transfer function h_{R}(θ_{S}) for the right ear to the mixing data MDI to generate right sound data SDR. In step S213, the processing apparatus 1 applies the head-related transfer function h_{L}(θ_{S}) for the left ear to the mixing data MDI to generate the left sound data SDL. Finally, in step S214, the processing apparatus 1 generates first sound data including the right sound data SDR and the left sound data SDL.

Note that the specific procedure of the volume panning processing step S220 in FIG. 17 is the same as the procedure in FIG. 7, and thus illustration and description thereof will be omitted. Similarly, the specific procedure of the correction processing step S230 in FIG. 17 is the same as the procedure in FIG. 8, and thus illustration and description thereof will be omitted.

According to the above described processing apparatus 1 of the third embodiment, even when the sound source data SDI is a sound having only a narrow frequency spectrum, a noise sound in a wide band in which a direction is easily perceived is added, and thus sound data for the listener U to perceive the direction of the sound more easily can be generated. In addition, according to the processing apparatus 1 of the third embodiment, the same effects as those of the processing apparatus 1 of any one of the first to second embodiments can be obtained.

### 1-4. Fourth Embodiment

As below, regarding the processing apparatus 1 of the fourth embodiment, the same configurations as those of any one of the first embodiment to the third embodiment will have the same signs, the same descriptions as those of any one of the first embodiment to the third embodiment will be omitted or simplified, and the differences from any one of the first embodiment to the third embodiment will be mainly described.

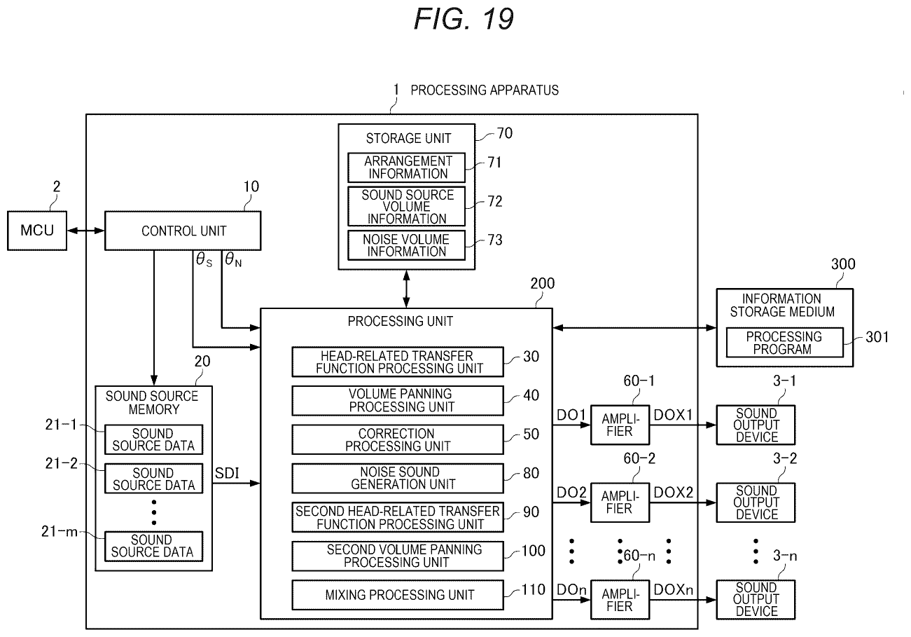

FIG. 19 shows a configuration example of a processing apparatus 1 of the fourth embodiment. As illustrated in FIG. 19, the processing apparatus 1 of the fourth embodiment includes a control unit 10, a sound source memory 20, n amplifiers 60-1 to 60-n, a storage unit 70, and a processing unit 200. The processing apparatus 1 may be a one-chip semiconductor integrated circuit device, may include a plurality of chips of semiconductor integrated circuit devices, or may include electronic components at least partially not semiconductor integrated circuit devices. For example, the control unit 10, the storage unit 70, and the processing unit 200 may be implemented by a one-chip semiconductor integrated circuit device, and the sound source memory 20 and the amplifiers 60-1 to 60-n may be provided outside the semiconductor integrated circuit device. The processing apparatus 1 may have a configuration in which part of the component elements in FIG. 19 are omitted or changed, or other component elements are added. For example, the amplifiers 60-1 to 60-n may not be the component elements of the processing apparatus 1.

The processing unit 200 acquires sound source data SDI, performs predetermined calculation processing, and outputs n-channels of sound data DO1 to DOn. Specifically, the processing unit 200 executes a processing program 301 stored in an information storage medium 300 and performs various types of calculation processing on the sound source data SDI. The processing unit 200 is implemented by, for example, a CPU or a DSP. CPU is an abbreviation for Central Processing Unit, and DSP is an abbreviation for Digital Signal Processor. The information storage medium 300 is implemented by, for example, a hard disk, a flexible disk, an MO, an MT, various memories, a CD-ROM, a DVD-ROM, or the like.

By executing the processing program 301, the processing unit 200 functions as the head-related transfer function processing unit 30, the volume panning processing unit 40, the correction processing unit 50, the noise sound generation unit 80, the second head-related transfer function processing unit 90, the second volume panning processing unit 100, and the mixing processing unit 110, and executes each procedure in the flowchart illustrated in FIG. 12. In other words, the processing program 301 is a program that causes the processing apparatus 1 as a computer to execute each procedure in the flowchart illustrated in FIG. 12. As described above, the processing apparatus 1 of the fourth embodiment realizes the same functions as those of the processing apparatus 1 of the second embodiment by the processing unit 200 executing the processing program 301.

The processing unit 200 may function as the head-related transfer function processing unit 30, the volume panning processing unit 40, and the correction processing unit 50 by executing the processing program 301, and may execute each procedure in the flowchart illustrated in FIG. 5. In other words, the processing program 301 may be a program that causes the processing apparatus 1 as a computer to execute each procedure in the flowchart illustrated in FIG. 5. That is, the processing apparatus 1 of the fourth embodiment may realize the same functions as those of the processing apparatus 1 of the first embodiment by the processing unit 200 executing the processing program 301.

The processing unit 200 may function as the head-related transfer function processing unit 30, the volume panning processing unit 40, the correction processing unit 50, and the mixing processing unit 110 by executing the processing program 301, and may execute each procedure in the flowchart illustrated in FIG. 17. In other words, the processing program 301 may be a program that causes the processing apparatus 1 as a computer to execute each procedure in the flowchart illustrated in FIG. 17. That is, the processing apparatus 1 of the fourth embodiment may realize the same functions as those of the processing apparatus 1 of the third embodiment by the processing unit 200 executing the processing program 301.

According to the above described processing apparatus 1 of the fourth embodiment, the same effects as those of any of the first to third embodiments can be obtained.

### 2. Electronic Apparatus

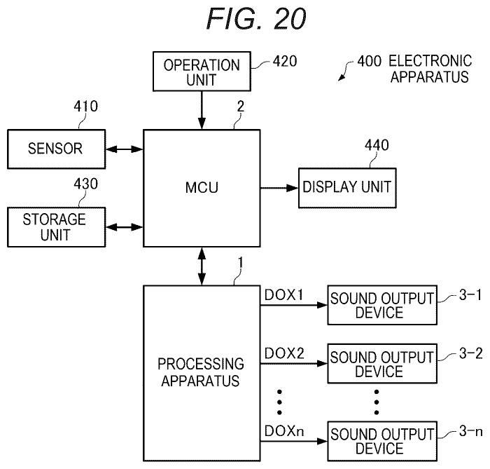

FIG. 20 is a functional block diagram showing a configuration example of an electronic apparatus using the processing apparatus 1 of any one of the above described embodiments. In FIG. 20, the same component elements as those shown in FIG. 1, 9, 16, or 19 have the same signs.

As illustrated in FIG. 20, an electronic apparatus 400 of the embodiment includes a processing apparatus 1, a micro control unit 2, n sound output devices 3-1 to 3-n, a sensor 410, an operation unit 420, a storage unit 430, and a display unit 440. The electronic apparatus 400 of the embodiment may have a configuration in which part of the component elements in FIG. 20 are omitted or changed, or other component elements are added.

The MCU 2 performs control processing of the individual units of the electronic apparatus 400 and various kinds of data processing. For example, the MCU 2 transmits various commands to the processing apparatus 1 and controls the operation of the processing apparatus 1. The MCU 2 performs various kinds of processing according to detection signals from the sensor 410, various kinds of processing according to operation signals from the operation unit 420, processing of transmitting display signals for displaying various types of information on the display unit 440, and the like.

The sensor 410 may be any sensor such as an acceleration sensor, an angular velocity sensor, a velocity sensor, a pressure sensor, or a temperature sensor, and outputs a detection signal to the MCU 2.

The operation unit 420 is an input device including operation keys, button switches, and the like, and outputs an operation signal in response to a user's operation to the MCU 2.

The storage unit 430 stores programs, data, and the like for the MCU 2 to perform various kinds of calculation processing and control processing. The storage unit 430 is implemented by, for example, a hard disk, a flexible disk, an MO, an MT, various memories, a CD-ROM, a DVD-ROM, or the like.

The display unit 440 is a display device including an LCD or the like, and displays various types of information based on the input display signal. LCD is an abbreviation for Liquid Crystal Display. The display unit 440 may be provided with a touch panel that functions as the operation unit 420.

The processing apparatus 1 generates sound signals DOX1 to DOXn based on various commands transmitted from the MCU 2, and outputs the sound signals DOX1 to DOXn to the sound output devices 3-1 to 3-n, respectively. The sound output devices 3-1 to 3-n output sounds corresponding to the sound signals DOX1 to DOXn, respectively.

For example, the MCU 2 may transmit a command, for instructing to reproduce a warning sound for calling attention, to the processing apparatus 1 based on the detection signal from the sensor 410. Further, for example, the MCU 2 may transmit a command, for instructing to reproduce a voice for guidance, to the processing apparatus 1 based on the operation signal from the operation unit 420. Furthermore, for example, the MCU 2 may transmit a command for reproducing various sounds such as a sound effect, a voice, and a melody to the processing apparatus 1 at a predetermined time. The processing apparatus 1 reads sound source data stored in the sound source memory 20, generates sound signals DOX1 to DOXn, and outputs the sound signals to the sound output devices 3-1 to 3-n, respectively. Accordingly, sounds output from any two of the sound output devices 3-1 to 3-n are mixed at the listening position P_{U}, and thereby, various warning sounds, effect sounds, voices, melodies, and the like in which the sense of direction is emphasized are reproduced.

As the electronic apparatus 400, various electronic apparatus are conceivable, and examples thereof include a warning device, a television, a car navigation device, an electronic game machine, a fish finder, various measurement devices, instruments of a vehicle, an aircraft, a ship, and the like, a flight simulator, a head-mounted display, and the like.

The present disclosure is not limited to the embodiments, and various modifications can be made within the scope of the gist of the present disclosure.

The above described embodiments and modification examples are merely examples, and the present disclosure is not limited thereto. For example, the respective embodiments and the respective modification examples may be combined as appropriate.

The present disclosure includes substantially the same configurations as the configurations described in the embodiments, for example, configurations having the same functions, methods, and results or configurations having the same purposes and effects. The present disclosure includes a configuration in which a non-essential portion of the configuration described in the embodiments is replaced. Further, the present disclosure includes a configuration that exerts the same function and effect or a configuration that can achieve the same purpose as the configurations described in the embodiments. Furthermore, the present disclosure includes a configuration with the addition of a known technique to the configuration described in the embodiments.

The following configurations are derived from the above described embodiments and modification examples.

A processing apparatus according to an aspect includes a head-related transfer function processing unit that applies a head-related transfer function corresponding to an angle of a virtual sound source with respect to a listening position to monaural sound source data to generate stereo first sound data, a volume panning processing unit that performs volume panning processing on the first sound data based on the angle of the virtual sound source to generate stereo second sound data, and a correction processing unit that corrects a delay amount and a volume of the second sound data based on arrangement information of a plurality of sound output devices to generate stereo third sound data to be output by two of the plurality of sound output devices.

According to the processing apparatus, the sound data with the addition of the frequency characteristics for the listener to easily instantaneously sense the direction can be generated by the head-related transfer function processing. Further, according to the processing apparatus, a state in which the plurality of sound output devices are virtually concentrically arranged can be created by the processing of correcting the delay amount and the sound volume of the sound data, and thereby, the sound volume panning processing can be applied even when the plurality of sound output devices are not concentrically arranged, and the sound data in which the listener can easily perceive the direction of the sound can be generated.

In the processing apparatus according to the aspect, the correction processing unit may correct the delay amount of the second sound data with reference to a distance from the listening position to the farthest sound output device among the plurality of sound output devices, and may correct the volume of the second sound data with reference to a distance from the listening position to the farthest sound output device or a distance to the closest sound output device among the plurality of sound output devices.

The processing apparatus according to the aspect may further include a second head-related transfer function processing unit that applies a head-related transfer function corresponding to an angle of a virtual noise source with respect to the listening position to monaural noise source data to generate stereo first noise data, a second volume panning processing unit that performs volume panning processing on the first noise data based on the angle of the virtual noise source to generate stereo second noise data, and a mixing processing unit that mixes the second sound data and the second noise data to generate mixing data, wherein the correction processing unit may correct a delay amount and a volume of the second sound data contained in the mixing data based on the arrangement information to generate the third sound data, and may correct a delay amount and a volume of the second noise data contained in the mixing data to generate third noise data.

According to the processing apparatus, even when the sound source data is a sound having only a narrow frequency spectrum, a noise sound in a wide band in which a direction is easily perceived is added, and thus sound data for the listener to perceive the direction of the sound more easily can be generated.

In the processing apparatus according to the aspect, the angle of the virtual sound source and the angle of the virtual noise source may be the same.

According to the processing apparatus, a noise sound in a wide band emitted by the virtual noise source in the same direction as the virtual sound source is added to the sound source data, and thus sound data for the listener to perceive the direction of the sound more easily can be generated.

In the processing apparatus according to the aspect, a difference between the angle of the virtual sound source and the angle of the virtual noise source may be 90° or more.

The processing apparatus according to the aspect may further include a mixing processing unit that mixes the sound source data and monaural noise source data to generate mixing data, wherein the head-related transfer function processing unit may apply a head-related transfer function corresponding to the angle of the virtual sound source with respect to the listening position to the mixing data to generate the first sound data.

According to the processing apparatus, even when the sound source data is a sound having only a narrow frequency spectrum, a noise sound in a wide band in which a direction is easily perceived is added, and thus sound data for the listener to perceive the direction of the sound more easily can be generated.

A processing method according to an aspect includes a head-related transfer function processing step of applying a head-related transfer function corresponding to an angle of a virtual sound source with respect to a listening position to monaural sound source data to generate stereo first sound data, a volume panning processing step of performing volume panning processing on the first sound data based on the angle of the virtual sound source to generate stereo second sound data, and a correction processing step of correcting a delay amount and a volume of the second sound data based on arrangement information of a plurality of sound output devices to generate stereo third sound data to be output by two of the plurality of sound output devices.

According to the processing method, the sound data with the addition of the frequency characteristics for the listener to easily instantaneously sense the direction can be generated by the head-related transfer function processing. Further, according to the processing method, a state in which the plurality of sound output devices are virtually concentrically arranged can be created by the processing of correcting the delay amount and the sound volume of the sound data, and thereby, the sound volume panning processing can be applied even when the plurality of sound output devices are not concentrically arranged, and the sound data in which the listener can easily perceive the direction of the sound can be generated.

A non-transitory computer-readable storage medium storing a processing program according to an aspect, the program causes a computer to execute a head-related transfer function processing step of applying a head-related transfer function corresponding to an angle of a virtual sound source with respect to a listening position to monaural sound source data to generate stereo first sound data, a volume panning processing step of performing volume panning processing on the first sound data based on the angle of the virtual sound source to generate stereo second sound data, and a correction processing step of correcting a delay amount and a volume of the second sound data based on arrangement information of a plurality of sound output devices to generate stereo third sound data to be output by two of the plurality of sound output devices.

According to the processing program, the sound data with the addition of the frequency characteristics for the listener to easily instantaneously sense the direction can be generated by the head-related transfer function processing. Further, according to the processing program, a state in which the plurality of sound output devices are virtually concentrically arranged can be created by the processing of correcting the delay amount and the sound volume of the sound data, and thereby, the sound volume panning processing can be applied even when the plurality of sound output devices are not concentrically arranged, and the sound data in which the listener can easily perceive the direction of the sound can be generated.

What is claimed is:

1. A processing apparatus comprising:
a head-related transfer function processing unit that applies a head-related transfer function corresponding to an angle of a virtual sound source with respect to a listening position to monaural sound source data to generate stereo first sound data;
a volume panning processing unit that performs volume panning processing on the first sound data based on the angle of the virtual sound source to generate stereo second sound data; and
a correction processing unit that corrects a delay amount and a volume of the second sound data based on arrangement information of a plurality of sound output devices to generate stereo third sound data to be output by two of the plurality of sound output devices.

2. The processing apparatus according to claim 1, wherein
the correction processing unit corrects the delay amount of the second sound data with reference to a distance from the listening position to the farthest sound output device among the plurality of sound output devices, and corrects the volume of the second sound data with reference to a distance from the listening position to the farthest sound output device or a distance to the closest sound output device among the plurality of sound output devices.

3. The processing apparatus according to claim 1, further comprising:
a second head-related transfer function processing unit that applies a head-related transfer function corresponding to an angle of a virtual noise source with respect to the listening position to monaural noise source data to generate stereo first noise data;
a second volume panning processing unit that performs volume panning processing on the first noise data based on the angle of the virtual noise source to generate stereo second noise data; and
a mixing processing unit that mixes the second sound data and the second noise data to generate mixing data, wherein
the correction processing unit corrects a delay amount and a volume of the second sound data contained in the mixing data based on the arrangement information to generate the third sound data, and corrects a delay amount and a volume of the second noise data contained in the mixing data to generate third noise data.

4. The processing apparatus according to claim 3, wherein
the angle of the virtual sound source and the angle of the virtual noise source are the same.

5. The processing apparatus according to claim 3, wherein
a difference between the angle of the virtual sound source and the angle of the virtual noise source is 90° or more.

6. The processing apparatus according to claim 1, further comprising a mixing processing unit that mixes the sound source data and monaural noise source data to generate mixing data, wherein
the head-related transfer function processing unit applies a head-related transfer function corresponding to the angle of the virtual sound source with respect to the listening position to the mixing data to generate the first sound data.

7. A processing method comprising:
a head-related transfer function processing step of applying a head-related transfer function corresponding to an angle of a virtual sound source with respect to a listening position to monaural sound source data to generate stereo first sound data;
a volume panning processing step of performing volume panning processing on the first sound data based on the angle of the virtual sound source to generate stereo second sound data; and
a correction processing step of correcting a delay amount and a volume of the second sound data based on arrangement information of a plurality of sound output devices to generate stereo third sound data to be output by two of the plurality of sound output devices.

8. A non-transitory computer-readable storage medium storing a processing program, the program causing a computer to execute:
a head-related transfer function processing step of applying a head-related transfer function corresponding to an angle of a virtual sound source with respect to a listening position to monaural sound source data to generate stereo first sound data;
a volume panning processing step of performing volume panning processing on the first sound data based on the angle of the virtual sound source to generate stereo second sound data; and
a correction processing step of correcting a delay amount and a volume of the second sound data based on arrangement information of a plurality of sound output devices to generate stereo third sound data to be output by two of the plurality of sound output devices.
